(19) United States
(12) Patent Application Publication
(10) Pub. No.: US 2017/0076162 A1
(43) Pub. Date: Mar. 16, 2017

(54) METHOD AND DEVICE FOR DETERMINING WHETHER THERE IS AN OBJECT IN THE SURROUNDINGS OF A MOTOR VEHICLE INSIDE A PARKING FACILITY

(71) Applicant: Robert Bosch GmbH, Stuttgart (DE)

(72) Inventor: Stefan Nordbruch, Kornwestheim (DE)

(21) Appl. No.: 15/261,182

(22) Filed: Sep. 9, 2016

(30) Foreign Application Priority Data
Sep. 11, 2015 (DE) 102015217385.2

(51) Int. Cl. G06K 9/00

(52) U.S. Cl. CPC G06K 9/00805

(57) ABSTRACT

A method for determining whether there is an object in the surroundings of a motor vehicle inside a parking facility, including providing first surroundings data from one or multiple surroundings sensor(s) of the motor vehicle, the first surroundings data corresponding to the surroundings of the motor vehicle detected with the aid of the one or multiple surroundings sensor(s) of the motor vehicle, providing second surroundings data from one or multiple surroundings sensor(s) of the parking facility, the second surroundings data corresponding to the surroundings of the motor vehicle detected with the aid of the one or multiple surroundings sensor(s) of the parking facility, determining, based on the first and second surroundings data, whether there is an object in the surroundings of the motor vehicle. A corresponding device, a motor vehicle, a parking facility and a computer program are also provided.

### CROSS REFERENCE

The present application claims the benefit under 35 U.S.C. §119 of German Patent Application No. DE 102015217385.2 filed on Sep. 11, 2015, which is expressly incorporated herein by reference in its entirety.

### FIELD

The present invention relates to a method and a device for determining whether there is an object in the surroundings of a motor vehicle inside a parking facility. The present invention also relates to a parking facility, a motor vehicle and a computer program.

### BACKGROUND INFORMATION

German Patent Application No. DE 10 2012 222 562 A1 describes a system for managed parking areas for transferring a motor vehicle from a starting position to a destination position.

It is important for the motor vehicle not to collide with any objects in its surroundings during a transfer.

### SUMMARY

An object of the present invention includes providing for efficient determination of whether there is an object in the surroundings of a motor vehicle situated inside a parking facility.

According to one aspect of the present invention, a method for determining whether there is an object in the surroundings of a motor vehicle inside a parking facility is provided, including the following steps:
providing first surroundings data of one or multiple surroundings sensor(s) of the motor vehicle, the first surroundings data corresponding to the surroundings of the motor vehicle detected with the aid of the one or multiple surroundings sensor(s),
providing second surroundings data from one or multiple surroundings sensor(s) of the parking facility, the second surroundings data corresponding to the surroundings detected with the aid of the one or multiple surroundings sensor(s) of the parking facility,
determining whether, based on the first and second surroundings data, there is an object in the surroundings of the motor vehicle.

According to a further aspect of the present invention, a device for determining whether there is an object in the surroundings of a motor vehicle inside a parking facility is provided, including:
a device for providing first surroundings data from one or multiple surroundings sensor(s) of the motor vehicle, the first surroundings data corresponding to the surroundings of the motor vehicle detected with the aid of the one or multiple surroundings sensor(s) of the motor vehicle, and
for providing second surroundings data from one or multiple surroundings sensor(s) of a parking facility, the second surroundings data corresponding to the surroundings of the motor vehicle detected with the aid the one or multiple surroundings sensor(s) of the parking facility and
a computer for determining, based on the first and second surroundings data, whether there is an object in the surroundings of the motor vehicle.

According to another aspect, a motor vehicle including the device according to the present invention is provided.

According to another aspect, a parking facility including the device according to the present invention is provided.

According to yet another aspect, a computer program which includes program code for carrying out the method according to the present invention is provided when the computer program is executed on a computer.

The present invention thus also includes in particular and among other things using the surroundings data from the surroundings sensors of the motor vehicle as well as the surroundings data from the surroundings sensors of the parking facility to determine whether there is an object in the surroundings of the motor vehicle. In other words, not only are the surroundings data from the surroundings sensors of the motor vehicle being used as the sole basis for deciding as to whether there is an object in the surroundings of the motor vehicle, but also the surroundings data from the surroundings sensors of the parking facility are used as the basis for deciding whether there is an object in the surroundings of the motor vehicle.

Therefore, more information is advantageously available as the basis for the decision in comparison with the case when only the surroundings data from the surroundings sensors of the motor vehicle or the surroundings data from the surroundings sensors of the parking facility are used. Therefore, this yields in particular the technical advantage that it is possible to determine efficiently whether there is an object in the surroundings of the motor vehicle.

When the plural for surroundings sensors is used, this should always be understood to imply the singular and vice-versa.

A parking facility in the sense of the present invention may also be referred to as a parking area and is used as a place to park motor vehicles. The parking facility thus forms in particular a contiguous area, which has multiple parking spaces (in the case of a parking facility on private property) or parking positions (in the case of a parking facility on public property). According to one specific embodiment, the parking facility is designed as a parking deck. According to another specific embodiment, the parking facility is designed as a parking garage.

Surroundings sensors in the sense of the present invention include, for example, the following surroundings sensors: video sensors, radar sensors, ultrasonic sensors, LIDAR sensors, laser sensors, magnetic sensors, sensor barriers and infrared sensors.

Surroundings of the motor vehicle refer in particular to an area around the motor vehicle extending up to a maximum distance of 20 meters, for example, 15 meters, preferably 10 meters, in particular 5 meters from the motor vehicle.

According to another specific embodiment, it is provided that, based on the first surroundings data, it is ascertained whether there is an object in the surroundings of the motor vehicle, based on the second surroundings data, it being ascertained whether there is an object in the surroundings of the motor vehicle, whereby, when it has already been found in one of the two steps of ascertaining that there is an object in the surroundings of the motor vehicle, it is determined that there is an object in the surroundings of the motor vehicle.

Therefore, this yields in particular the technical advantage that the safety for the motor vehicle or for other traffic participants in the surroundings of the motor vehicle may be increased and a collision risk for the motor vehicle may be efficiently reduced. If it has been found incorrectly in one of the steps of ascertaining that there is no object in the surroundings of the motor vehicle, then this error may be compensated by the fact that it is correctly determined in another step of ascertaining that there is an object in the surroundings of the motor vehicle.

According to another specific embodiment, it is provided that the ascertaining, based on the first and/or second surroundings data, includes the fact that, based on the respective surroundings data from the corresponding surroundings sensors, it is ascertained individually for each surroundings sensor whether there is an object in the surroundings of the motor vehicle, whereby, when it has already been found, based on the surroundings data from a single surroundings sensor, that there is an object in the surroundings of the motor vehicle, it is determined that there is an object in the surroundings of the motor vehicle.

Therefore, this yields in particular the technical advantage that the collision risk for the motor vehicle may be further reduced efficiently because now even an analysis of the surroundings, based on surroundings data from a single surroundings sensor, is sufficient to determine that there is an object in the surroundings of the motor vehicle if this analysis of the surroundings has revealed that there is an object in the surroundings of the motor vehicle.

Therefore, malfunctions of a surroundings sensor resulting in the surroundings sensor falsely not detecting an object may be compensated if other surroundings sensors detect the object correctly.

According to another specific embodiment, it is provided that the first and/or second surroundings data include surroundings sensor raw data, which are fused among and/or with each another to ascertain fused surroundings data, it being ascertained on the basis of the fused surroundings data whether there is an object in the surroundings of the motor vehicle, whereby, when it is found in the step of ascertaining that there is an object in the surroundings of the motor vehicle, it is determined that there is an object in the surroundings of the motor vehicle.

Therefore, this yields in particular the technical advantage that even more accurate and more precise knowledge of the surroundings of the motor vehicle is ascertainable. Therefore, for example, it is possible to advantageously ascertain with an even greater accuracy whether there is an object in the surroundings of the motor vehicle.

According to another specific embodiment, it is provided that at least the step of determining is carried out with the aid of a first computer installed in the motor vehicle, at least one of the steps of determining additionally being carried out with the aid of a second computer provided outside of the motor vehicle, whereby, when it has already been found in one of the two steps of determining that there is an object in the surroundings of the motor vehicle, it is determined that there is an object in the surroundings of the motor vehicle.

Therefore, this yields the technical advantage in particular that a collision risk for the motor vehicle may be further reduced or lowered efficiently because, for example, if the computer in the motor vehicle has a malfunction and falsely decides that there is an object in the surroundings of the motor vehicle, this error may be compensated by the computer of the parking facility if the latter correctly determines that there is an object in the surroundings of the motor vehicle.

According to one specific embodiment, it is provided that the device for determining whether there is an object in the surroundings of a motor vehicle inside a parking facility is designed or configured to execute or carry out the method for determining whether there is an object in the surroundings of a motor vehicle inside the parking facility.

According to another specific embodiment, it is provided that the method is executed or carried out with the aid of the device.

According to one specific embodiment, the motor vehicle is set up to execute or carry out the method according to the present invention.

According to another specific embodiment, it is provided that the parking facility is set up to execute or carry out the method according to the present invention.

According to one specific embodiment, a parking facility management system includes the device. A parking facility management system is set up in particular to control and/or coordinate an operation of the parking facility.

According to one specific embodiment, the motor vehicle includes one or multiple surroundings sensor(s).

In another specific embodiment, the parking facility includes one or multiple surroundings sensor(s). This means that multiple surroundings sensors are situated inside the parking facility, for example.

According to one specific embodiment, it is provided that, based on the step of determining whether there is an object in the surroundings of the motor vehicle, the motor vehicle is operated based on the first and second surroundings data.

Operation of the motor vehicle includes in particular the fact that the motor vehicle is stopped. Stopping the motor vehicle is executed or carried out, for example, by transmitting an emergency stop signal to the motor vehicle via a communications network. According to one specific embodiment, in response to the emergency stop signal, it is provided that the motor vehicle carries out an emergency stop. According to one specific embodiment, the emergency stop signal is transmitted from the parking facility management system to the motor vehicle with the aid of a communications interface via a communications network. In another specific embodiment, it is provided that a remote control command is transmitted to the motor vehicle via a communications network in order to stop the motor vehicle by remote control. According to one specific embodiment, the remote control command is transmitted from the parking facility management system to the motor vehicle with the aid of a communications interface via the communications network.

According to one specific embodiment, a communications network includes a WLAN and/or a mobile network. According to one specific embodiment, a communications network includes a LoRa communications network. The abbreviation “LoRa” stands for “low-power wide-range communication.” According to one specific embodiment, the communications network thus includes a LoRa communications network.

In one specific embodiment, a communication via the communications network is encrypted.

According to one specific embodiment, the motor vehicle carries out an automatic parking operation inside the parking facility. In other words, the concept according to the present invention is applied according to one specific embodiment when the motor vehicle carries out an autonomous parking operation inside the parking facility. An autonomous parking operation may be referred to as an AVP operation. “AVP” stands for “automated valet parking” and may be translated as an automatic parking operation. Within the scope of an AVP operation, the motor vehicle automatically drives from a drop-off position, in which the driver of the motor vehicle has parked his/her motor vehicle to carry out the AVP operation, to a parking position inside the parking facility and is automatically parked there. An AVP operation includes the fact that the motor vehicle drives automatically from its parking position to a pickup position, where it is parked and where a user or a person is able to pick up or retrieve the motor vehicle.

Automatic driving includes, for example, the fact that the motor vehicle drives autonomously. Automatic driving includes, for example, the fact that the motor vehicle is controlled remotely. Within the scope of an AVP operation, it is thus no longer necessary for a driver to remain in the motor vehicle in order to manually drive the motor vehicle. Within the scope of an AVP operation, it is thus provided in particular that the motor vehicle is guided and/or driven without a driver.

The present invention is explained in greater detail below on the basis of preferred exemplary embodiments.

### BRIEF DESCRIPTION OF THE DRAWINGS

FIG. 1 shows a flow chart of a method for determining whether there is an object in the surroundings of a motor vehicle inside a parking facility.

FIG. 2 shows a device for determining whether there is an object in the surroundings of a motor vehicle inside a parking facility.

FIG. 3 shows a motor vehicle.

FIG. 4 shows a parking facility.

FIG. 5 shows the result of a fusion of surroundings sensor data.

### DETAILED DESCRIPTION OF EXAMPLE EMBODIMENTS

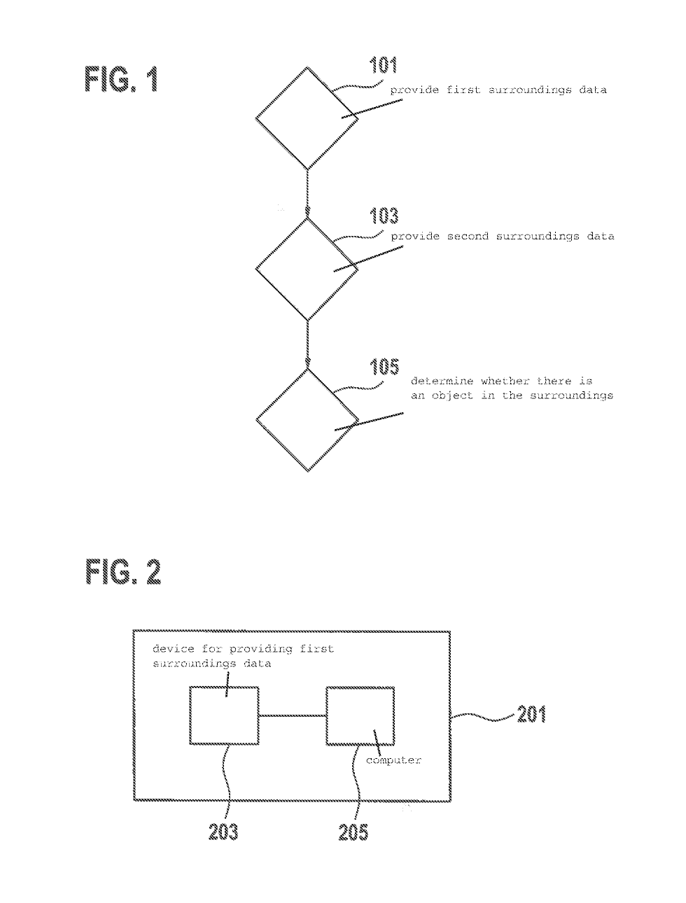

FIG. 1 shows a flow chart of a method for determining whether there is an object in the surroundings of a motor vehicle inside a parking facility.

This method includes the following steps:
providing 101 first surroundings data from one or multiple surroundings sensor(s) of the motor vehicle, the first surroundings data corresponding to the surroundings of the motor vehicle detected with the aid of the one or multiple surroundings sensor(s) of the motor vehicle,
providing 103 second surroundings data from one or multiple surroundings sensor(s) of the parking facility, the second surroundings data corresponding to the surroundings of the motor vehicle, detected with the aid of the one or multiple surroundings sensor(s) of the parking facility,
determining 105, based on the first and second surroundings data, whether there is an object in the surroundings of the motor vehicle.

According to one specific embodiment, it is provided that the second surroundings data are received by the motor vehicle via a communications network.

In another specific embodiment, it is provided that the first surroundings data are received by a parking facility management system via a communications network.

According to one specific embodiment, it is provided that at least the step of determining is carried out with the aid of a first computer installed in the motor vehicle, at least the step of determining being additionally carried out with the aid of a second computer provided outside of the motor vehicle, whereby, if it is found already in one of the two steps of determining that there is an object in the surroundings of the motor vehicle, it is determined that there is an object in the surroundings of the motor vehicle.

In another specific embodiment, it is provided that at least one or all of the steps described above or below for ascertaining whether there is an object in the surroundings of the motor vehicle is/are carried out with the aid of a computer in the motor vehicle.

In another specific embodiment, it is provided that at least one or all of the steps described above or below for ascertaining whether there is an object in the surroundings of the motor vehicle is/are carried out with the aid of a computer of the parking facility management system.

FIG. 2 shows a device 201 for determining whether there is an object in the surroundings of a motor vehicle inside a parking facility.

Device 201 includes:
a device 203 for providing first surroundings data from one or multiple surroundings sensor(s) of the motor vehicle, the first surroundings data corresponding to the surroundings of the motor vehicle detected with the aid of the one or multiple surroundings sensor(s) of the motor vehicle, and
for providing second surroundings data from one or multiple surroundings sensor(s) of a parking facility, the second surroundings data corresponding to the surroundings of the motor vehicle detected with the aid of the one or multiple surroundings sensor(s) of the parking facility, and
a computer 205 for determining, based on the first and second surroundings data, whether there is an object in the surroundings of the motor vehicle.

According to one specific embodiment, it is provided that device 201 includes a communications interface for receiving and/or transmitting surroundings data via a communications network.

Depending on whether a motor vehicle or a parking facility includes device 201, the communications interface is thus designed accordingly to receive first surroundings data and to transmit second surroundings data or vice versa.

The word “respectively” generally includes the phrase “and/or.”

In another specific embodiment, it is provided that the computer of device 201 is designed to execute or carry out at least one or all the steps of ascertaining whether there is an object in the surroundings of the motor vehicle.

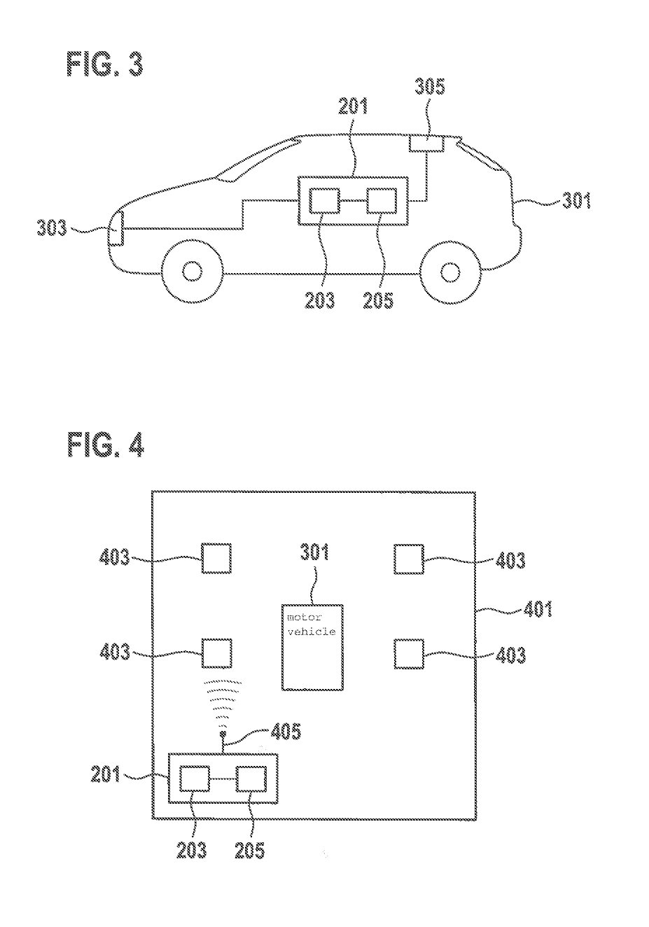

FIG. 3 shows a motor vehicle 301.

Motor vehicle 301 includes device 201 of FIG. 2. Motor vehicle 301 also includes a radar sensor 303 as a surroundings sensor, which is situated on the front of motor vehicle 301. Motor vehicle 301 also includes a communications interface 305 for communicating via a communications network.

This means that the communications interface 305 is designed to communicate via a communications network.

Radar sensor 303 detects the surroundings of motor vehicle 301 and makes the surroundings data available corresponding to the detected surroundings. These surroundings data are referred to as first surroundings data. Motor vehicle 301 according to a first specific embodiment receives second surroundings data via communications interface 305, the second surroundings data corresponding to the surroundings of the motor vehicle detected with the aid of the one or multiple surroundings sensor(s) of the parking facility. Thus, for example, computer 205 of device 201 ascertains, based on the first surroundings data, whether there is an object in the surroundings of motor vehicle 301.

According to another specific embodiment, computer 205 ascertains, based on the received second surroundings data, whether there is an object in the surroundings of the motor vehicle. Depending on these two steps of ascertaining, computer 205 determines whether there is an object in the surroundings of motor vehicle 301.

In another specific embodiment, it is provided that a result of ascertaining whether there is an object in the surroundings of motor vehicle 301 is received with the aid of communications interface 305. This result is used by computer 205 as the basis for deciding whether it is possible to determine that there is an object in the surroundings of motor vehicle 301. For example, if ascertaining, based on the first surroundings data from radar sensor 303, has revealed that there is no object in the surroundings of the motor vehicle, but the result received indicates that there is an object in the surroundings of the motor vehicle, then computer 205 will come to the decision that there is an object in the surroundings of motor vehicle 301.

For example, if ascertaining, based on the first surroundings data from radar sensor 303, has revealed that there is an object in the surroundings of motor vehicle 301, then it is at any rate determined with the aid of computer 205, independently of a received result, that there is an object in the surroundings of motor vehicle 301.

FIG. 4 shows a parking facility 401 for motor vehicles.

Parking facility 401 includes device 201 from FIG. 2. In addition, device 201 includes a communications interface 405, which is designed to communicate via a wireless communications network. For example, communications interface 405 is designed to communicate with motor vehicle 301, more specifically with communications interface 305 of motor vehicle 301. Motor vehicle 301 drives inside parking facility 401. For the sake of clarity, only motor vehicle 301 is schematically shown without the additional elements, which are additionally shown in FIG. 3.

Parking facility 401 includes multiple surroundings sensors 403, which are designed as video sensors, for example. According to additional specific embodiments, surroundings sensors 403 are each designed as surroundings sensors, as described above.

Multiple surroundings sensors 403 detect the surroundings of motor vehicle 301 and ascertain surroundings data corresponding to the detected surroundings. These surroundings data are supplied to device 201. For example, surroundings sensors 403 transmit the respective surroundings data to communications interface 405 via the wireless communications network. According to one specific embodiment, surroundings sensors 403 are connected to device 201 via a hard-wired communications network.

Computer 205 of device 201 of parking facility 401 ascertains, based on these surroundings data, which may be identified as the second surroundings data for better differentiability, whether there is an object in the surroundings of motor vehicle 301. For example, this result is transmitted to motor vehicle 301 with the aid of communications interface 405. According to one specific embodiment, it is provided that communications interface 405 receives the first surroundings data of motor vehicle 301. This means that motor vehicle 301 transmits its first surroundings data and/or its ascertained result to device 201 with the aid of communications interface 305 via the wireless communications network. According to one specific embodiment, computer 205 of device 201 of parking facility 401 will use these first surroundings data and/or this result as a basis for deciding to determine whether there is an object in the surroundings of motor vehicle 301.

According to one specific embodiment, depending on the result of determining whether there is an object in the surroundings of motor vehicle 301, it is provided that motor vehicle 301 is being operated. For example, motor vehicle 301 is stopped automatically when the determination has revealed that there is an object in the surroundings of motor vehicle 301. For example, communications interface 405 transmits an emergency stop signal to motor vehicle 301. Motor vehicle 301 will automatically carry out an emergency stop in response to receiving the emergency stop signal.

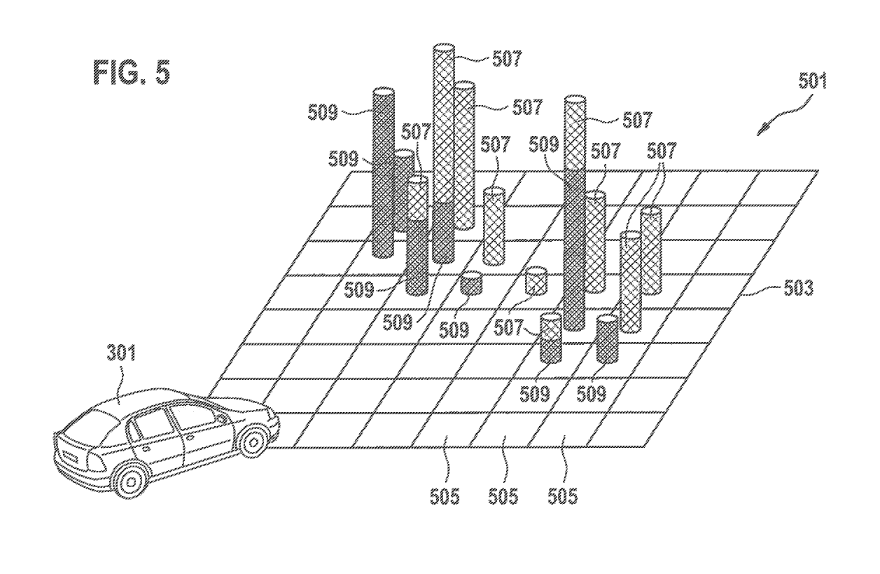

FIG. 5 shows in a schematic form a result of a fusion of surroundings sensor raw data.

This shows surroundings 501 of motor vehicle 301.

The surroundings of motor vehicle 501 are subdivided into a grid 503 including multiple grid cells 505. Grid cells 505 are formed as a square, for example, and represent an area of one meter by one meter, for example.

The surroundings sensor raw data from the individual surroundings sensors of motor vehicle 301 and/or of parking facility 401 are fused among and/or with each other and the corresponding fused surroundings data are plotted in respective grid cells 505.

Columns 507 here represent the fused surroundings data from the surroundings sensors of parking facility 401. Columns 507 represent the fused surroundings data from the surroundings sensors of motor vehicle 301.

Depending on this fusion, there is then a determination of whether there is an object in the surroundings of the motor vehicle.

In summary, the present invention provides an efficient and technical solution, on the basis of which it is possible to determine efficiently whether there is an object in the surroundings of a motor vehicle inside a parking facility. According to the present invention, there is an analysis of whether one or multiple objects is/are present in a defined space around the motor vehicle. According to the present invention, information from two monitoring systems:
surroundings sensors of the parking facility (parking facility infrastructure surroundings sensor system) and
surroundings sensors of the motor vehicle (motor vehicle surroundings sensor system)

are combined and/or used for an overall analysis to decide or determine whether one or multiple objects is/are in the surroundings of the motor vehicle.

The parking facility infrastructure surroundings sensor system includes, for example, cameras which may include one video sensor or multiple video sensors. The parking facility infrastructure surroundings sensor system includes, for example, additional surroundings sensors.

The motor vehicle surroundings sensor system includes, for example, one or multiple surroundings sensor(s), such as those described above.

In combining the two types of information, which may be ascertained on the basis of the two surroundings sensor systems, an object-based and/or raw data-based combination is provided, for example. This is explained in greater detail below.

In an object-based combination, it is provided that the objects in the two monitoring systems (motor vehicle and parking facility management system) are ascertained in advance from the surroundings sensor raw data from the surroundings sensors, and the results are then combined in the form of objects. For example, this means that objects (if present) are ascertained by the cameras of the parking facility infrastructure monitoring system. This is also carried out accordingly in the motor vehicle with the aid of the motor vehicle surroundings sensor system. It is then provided that, in a subsequent step, these object results are combined. For reasons of safety, when an object has been ascertained in one of the surroundings sensors, it is always assumed here that an object is present. This is regardless of whether an object or no object has been ascertained with the aid of another surroundings sensor.

The following examples shall explain this more closely:

### EXAMPLE 1

A parking facility management system ascertains that an object is present in the surroundings of the motor vehicle. The motor vehicle itself ascertains that no object is present in the surroundings of the motor vehicle. It is nevertheless determined and assumed here that there is an object in the surroundings of the motor vehicle.

### EXAMPLE 2

The parking facility management system ascertains that there is an object. The motor vehicle also ascertains that there is an object in the surroundings of the motor vehicle. Thus, as a result, it is assumed, i.e., determined, that there is an object in the surroundings of the motor vehicle.

If multiple surroundings sensors are provided in both monitoring systems (motor vehicle and parking facility management system), for example, a radar sensor and a video sensor in the motor vehicle, then in one specific embodiment, the principle according to the present invention is applied to all surroundings sensors of both systems. The following example explains this more closely:

In the motor vehicle, it is detected with the aid of the radar sensor that there is an object in the surroundings of the motor vehicle. With the aid of the video camera of the motor vehicle it is detected that there is no object in the surroundings of the motor vehicle. A parking facility video camera ascertains that there is an object in the surroundings of the motor vehicle. As the overall decision, it is thus determined that there is an object in the surroundings of the motor vehicle.

In another specific embodiment, the solution according to the present invention is used as a cascade initially in the individual monitoring systems (motor vehicle and parking facility management system) and then via the two systems. The following example shall explain this more closely:

Based on a parking facility video camera, it is ascertained that there is an object in the surroundings of the motor vehicle. Based on a parking facility sensor barrier, it is ascertained that there is an object in the surroundings of the motor vehicle. As an interim result, it is determined that there is an object in the surroundings of the motor vehicle.

Based on the radar sensor of the motor vehicle, it is ascertained that there is no object in the surroundings of the motor vehicle. Based on a video camera of the motor vehicle, it is ascertained that there is no object in the surroundings of the motor vehicle. As an interim result, it is determined that there is no object in the surroundings of the motor vehicle.

However, based on these two interim results, it is ultimately determined that there is an object in the surroundings of the motor vehicle.

A combination based on raw data would be as follows, for example:

In one specific embodiment, the surroundings sensor raw data are combined for an analysis of whether there is an object in the surroundings of the motor vehicle. In other words, for example, this means that, instead of being detected by the individual surroundings sensors, the objects and/or the position of the objects are calculated from reflections, for example, or points, for example, the surroundings sensor raw data are combined in an analysis, and the position of an object is calculated, for example. This means that the surroundings sensor raw data from the individual surroundings sensors are fused among and/or with each other for this combination.

For example, according to one specific embodiment the so-called

GRID method is used here. The GRID method includes the fact that the individual raw data are plotted in a checkerboard (one square of the checkerboard represents an area of one meter by one meter, for example). This is illustrated in FIG. 5. For example, it is provided that the fusion schematically diagrammed in FIG. 5 has been carried out in such a way that columns 509 represent the surroundings sensor raw data from the radar sensor of the motor vehicle. Columns 507 represent, for example, the video raw data from a video camera of the parking facility. It is then provided according to one specific embodiment that it is ascertained or determined based on the surroundings sensor raw data from the two sensors whether there is an object in the surroundings of the motor vehicle.

In one specific embodiment, it is provided that the analysis is carried out on a system (motor vehicle or parking facility management system).

In another specific embodiment, it is provided that the analysis is carried out on the two systems independently of one another. If the result “object present” is ascertained with the aid of one system, then for safety reasons this is also used as a final result. This means that, if it has already been determined with the aid of the first computer or with the aid of the second computer, that there is an object in the surroundings of the motor vehicle, this result stands. This is also the case if the other system, i.e., the other computer, determines that there is no object in the surroundings of the motor vehicle.

In one specific embodiment, it is provided that, in the presence of multiple surroundings sensors, one or multiple combinations of the above described steps of ascertaining whether there is an object in the surroundings of the motor vehicle or of determining, respectively, whether there is an object in the surroundings of the motor vehicle, are combined with each other. This means, for example, that raw data-based calculations are first carried out in the individual systems and, subsequently, the two results about objects are combined.

What is claimed is:

1. A method for determining whether there is an object in the surroundings of a motor vehicle inside a parking facility, the method comprising:
providing first surroundings data from at least one surroundings sensor of the motor vehicle, the first surroundings data corresponding to surroundings of the motor vehicle detected with the aid of at least one surroundings sensor of the motor vehicle;
providing second surroundings data from at least one surroundings sensor of the parking facility, the second surroundings data corresponding to the surroundings of the motor vehicle detected with the aid of the at least one surroundings sensor of the parking facility;
determining, based on the first and second surroundings data, whether there is an object in the surroundings of the motor vehicle.

2. The method as recited in claim 1, wherein the determining step includes:
ascertaining based on the first surroundings data whether there is an object in the surroundings of the motor vehicle; and
ascertaining based on the second surroundings data whether there is an object in the surroundings of the motor vehicle;
determining that there is an object in the surroundings of the motor vehicle when an object is detected in one of the ascertaining based on the first surroundings data and ascertaining based on the second surroundings data.

3. The method as recited in claim 2, wherein the ascertainment based on at least one of the first and second surroundings data includes that, based on the respective surroundings data from the corresponding surroundings sensors, it is ascertained for each surroundings sensor individually whether there is an object in the surroundings of the motor vehicle, whereby, when it is already detected, based on surroundings data from a single surroundings sensor, that there is an object in the surroundings of the motor vehicle, it is determined that there is an object in the surroundings of the motor vehicle.

4. The method as recited in claim 1, wherein at least one of the first and second surroundings data includes surroundings sensor raw data which are fused with each other to ascertain fused surroundings data, and based on the fused surroundings data, it being ascertained whether there is an object in the surroundings of the motor vehicle, whereby, when it is detected in the step of ascertaining that there is an object in the surroundings of the motor vehicle, it is determined that there is an object in the surroundings of the motor vehicle.

5. The method as recited in claim 1, wherein at least the step of determining is carried out with the aid of a first computer situated in the motor vehicle, at least the step of determining being additionally carried out with the aid of a second computer provided outside of the motor vehicle, whereby, if it has already been detected in one of the two steps of determining that there is an object in the surroundings of the motor vehicle, it is determined that there is an object in the surroundings of the motor vehicle.

6. A device for determining whether there is an object in the surroundings of a motor vehicle inside a parking facility, comprising:
a device for providing first surroundings data from at least one surroundings sensor of the motor vehicle, the first surroundings data corresponding to surroundings of the motor vehicle detected with the aid of the at least one surroundings sensor of the motor vehicle, and for providing second surroundings data from at least one surroundings sensor of a parking facility, the second surroundings data corresponding to surroundings of the motor vehicle detected with the aid of the at least one surroundings sensor of the parking facility; and
a computer for determining, based on the first and second surroundings data, whether there is an object in the surroundings of the motor vehicle.

7. A motor vehicle including a device for determining whether there is an object in the surroundings of a motor vehicle inside a parking facility, the device comprising:
a device for providing first surroundings data from at least one surroundings sensor of the motor vehicle, the first surroundings data corresponding to surroundings of the motor vehicle detected with the aid of the at least one surroundings sensor of the motor vehicle, and for providing second surroundings data from at least one surroundings sensor of a parking facility, the second surroundings data corresponding to surroundings of the motor vehicle detected with the aid of the at least one surroundings sensor of the parking facility; and
a computer for determining, based on the first and second surroundings data, whether there is an object in the surroundings of the motor vehicle.

8. A parking facility including a device for determining whether there is an object in the surroundings of a motor vehicle inside a parking facility, the device comprising:
a device for providing first surroundings data from at least one surroundings sensor of the motor vehicle, the first surroundings data corresponding to surroundings of the motor vehicle detected with the aid of the at least one surroundings sensor of the motor vehicle, and for providing second surroundings data from at least one surroundings sensor of the parking facility, the second surroundings data corresponding to surroundings of the motor vehicle detected with the aid of the at least one surroundings sensor of the parking facility; and
a computer for determining, based on the first and second surroundings data, whether there is an object in the surroundings of the motor vehicle.

9. A non-transitory computer-readable storage medium storing a computer program including program code for determining whether there is an object in the surroundings of a motor vehicle inside a parking facility, the program code, when executed by a computer, causing the computer to perform:
providing first surroundings data from at least one surroundings sensor of the motor vehicle, the first surroundings data corresponding to surroundings of the motor vehicle detected with the aid of at least one surroundings sensor of the motor vehicle;
providing second surroundings data from at least one surroundings sensor of the parking facility, the second surroundings data corresponding to the surroundings of the motor vehicle detected with the aid of the at least one surroundings sensor of the parking facility; and
determining, based on the first and second surroundings data, whether there is an object in the surroundings of the motor vehicle.
